(19) United States
(12) Patent Application Publication
(10) Pub. No.: US 2024/0403742 A1
(43) Pub. Date: Dec. 5, 2024

(54) Market Life Cycle Based Manufacturing Input Component Systems and Methods

(71) Applicant: Advantest Corporation, Tokyo (JP)

(72) Inventor: Jack Hongtao Du, San Jose, CA (US)

(21) Appl. No.: 18/204,201

(22) Filed: May 31, 2023

(51) Int. Cl. G06Q 10/0631; G06Q 10/0639; G06Q 50/04

(52) U.S. Cl. CPC G06Q 10/0631; G06Q 10/06393; G06Q 50/04

(57) ABSTRACT

Efficient and effective life cycle manufacturing input control systems and methods are presented. In one embodiment, a life cycle manufacturing input control method comprises: accessing market life cycle information associated with an input component to a manufacturing process, performing a KPI process, wherein the KPI process produces a KPI score, and configuring utilization of an input component to a manufacturing process based upon the KPI score. The KPI process can include: determining life cycle stage of the input component, assigning a confidence factor to the life cycle stage; and establishing a KPI score in the manufacture of test equipment.

### FIELD OF INVENTION

The present subject matter is related to the field of product manufacturing systems and methods, including configuring the manufacturing systems and methods in accordance with life cycle analysis and production component/material input availability.

### BACKGROUND

Various manufacturing components are input to manufacturing systems and methods of production (e.g., automatic test equipment (ATE) production, electronic device production, cell phone production, etc.). These input components (e.g., items, parts, material, etc.) are typically included in a list commonly referred to as a bill of materials (BOM). During the manufacturing of an object (e.g., automatic test equipment, electronic device, etc.) most input components on a BOM accompany the output product through the entire life cycle of the output product. The availability of input components included in the BOM typically have a significant impact on manufacturing efficiency and effectiveness of the output products (e.g., manufacturability, configuration of an ATE, delivery lead-time, cost, revenue, margin, etc.). For ease of understanding the term input component (e.g., part, components, materials, etc.) refers to inputs to a product manufacturing process and output product is the output of the manufacturing process.

Most companies rely on contract manufacturers (CM) to provide availability and shortage information for items in the BOM. Traditionally, critical information (e.g., last time to buy (LTB), replacement part search, new item qualification, and approval, etc.) is often detrimentally supplied with very short notice before adverse impacts (e.g., limited availability, obsolescence, etc.) to actual ATE manufacturing systems and methods occur. Some traditional literature indicates conventional reactive obsolescence mitigation approaches can provide 3:1 paybacks. Even with this payback ratio there are still issues that continue to introduce significant risk of problems for product manufacturing (e.g., such as delivery delay, insufficient qualification, excessive production cost, etc.). How to effectively forecast input component obsolescence/shortages typically was traditionally a daily challenge for manufacturing, especially for those manufacturing ATE systems with BOM lists of hundreds or even thousands of items/parts.

### SUMMARY

Efficient and effective life cycle manufacturing input control systems and methods are presented. In one embodiment, a life cycle manufacturing input control method comprises: accessing input component market life cycle information associated with an input component to a manufacturing process, performing a Key Performance Index (KPI) process, wherein the KPI process produces a KPI score, and configuring utilization of the input component in a manufacturing process based upon the KPI score. In one exemplary implementation, the manufacturing process comprises manufacture of automatic test equipment (ATE). In one embodiment, the KPI process comprises: determining a life cycle stage of the input component, assigning a confidence factor to the life cycle stage, and establishing a KPI score.

In one embodiment, the input component market life cycle information comprises active production availability information, inactive production availability information, and obsolescence information. In one exemplary implementation, the input component market life cycle information comprises: an input component/product “Active” section comprising an Active-Widely Available stage, an Active-Limited Available stage, and an Active-Minimum Order Quantity (MOQ) stage; an input component/product “Inactive” section comprising an Inactive-Not Recommend for New Design stage, an Inactive-Last Time to Buy/Last Available stage, and Inactive-Last Time Buy MOQ stage; and an input component/product “Obsolete” section comprising an Obsolete-Widely Available stage, an Obsolete-Limited Available stage, and an Obsolete-Limited Available stage. Stage features of the input component market life cycle information are analyzed.

In one embodiment, the Key Performance Index (KPI) score is defined by: KPI Score=CF×(P+α)×Q/CT, wherein CF is a confidence factor, P is a probability of obtaining an input component, α is a percentage of in-stock suppliers/distributors, Q is the quality of the bill of materials (BOM), C is the cost and T is the lead time. In one embodiment, configuring utilization of an input component in a manufacturing process comprises establishing a bill of material.

In one embodiment, a system comprises a processor and memory for storing instructions, wherein when the instructions are executed by the processor a life cycle manufacturing input control process/method is performed.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings may not be drawn to scale.

FIG. 1 is a block diagram of an exemplary testing system in accordance with one embodiment.

FIG. 2 is a block diagram of another exemplary testing system in accordance with one embodiment.

FIG. 3 is a block diagram of yet another exemplary test system in accordance with one embodiment.

FIG. 4A is a block diagram of an exemplary manufacturing process in accordance with one embodiment.

FIG. 4B is a block diagram of an exemplary a life cycle manufacturing input control method in accordance with one embodiment.

FIG. 5 is a block diagram of an exemplary input component/product manufacturing information flow in accordance with one embodiment.

FIG. 6 is a table of an exemplary BOM component timeline in accordance with one embodiment.

FIG. 7 is a block diagram of an exemplary input component availability health check flow in accordance with one embodiment.

FIG. 8 is a block diagram of an exemplary input component/product life cycle flow in accordance with one embodiment.

FIG. 9 is a block diagram illustrating difference between an exemplary input component/product life cycle flow and an input component market life cycle flow in accordance with one embodiment.

FIG. 10A is a block diagram of an exemplary market life cycle flow in accordance with one embodiment.

FIG. 10B is a flow chart of an exemplary a KPI score based component configuration method in accordance with one embodiment.

FIG. 11 is table of exemplary Market Life Cycle Stage Features in accordance with one embodiment.

FIG. 12 is a table of exemplary Stage Features Settings in accordance with one embodiment.

FIG. 13 is a table of exemplary confidence factor indications in accordance with one embodiment.

FIG. 14 is a table of exemplary market life cycle KPI score indications in accordance with one embodiment.

FIG. 15 is another block diagram of exemplary market life cycle KPI score indications in accordance with one embodiment.

FIGS. 16A and B is a flow chart of an exemplary method in accordance with one embodiment.

FIG. 17 is a flow chart of an exemplary process flow in accordance with one embodiment.

FIG. 18 is an illustration of exemplary BOM Control Module instructions in accordance with one embodiment.

FIG. 19 is an illustration of exemplary BOM Health Check Module instructions in accordance with one embodiment.

FIG. 20 is an illustration of exemplary KPI module instructions in accordance with one embodiment.

FIG. 21 is an illustration of exemplary BOM EOL module instructions in accordance with one embodiment.

FIG. 22 is a block diagram of an exemplary electronic system which may be used as a platform to implement and control a process in accordance with one embodiment.

### DETAILED DESCRIPTION

Reference will now be made to various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The accompanying drawings, which are incorporated in and form a part of this specification, are included for exemplary illustration of the principles of the present invention and are not intended to limit the present invention to the particular implementations illustrated therein. The drawings are not to scale unless otherwise specifically indicated.

The figures are not necessarily drawn to scale, and portions of the devices and structures depicted, as well as the various layers that form those structures, are shown. For simplicity of discussion and illustration, only one or two devices or structures may be described, although in actuality more than one or two devices or structures may be present or formed. Also, while certain elements, components, and layers are discussed, embodiments according to the invention are not limited to those elements, components, and layers. For example, there may be other elements, components, layers, and the like in addition to those discussed.

Presented novel systems and methods provide efficient and effective configuration of manufacturing systems and methods, including manufacturing input control processes. In one embodiment, a life cycle manufacturing input control system and method provides control of component input configurations to an output product manufacturing process/system. The output product is manufactured from various components that are input to the product manufacturing process. In one embodiment, the product is automated test equipment (ATE). The presented systems and methods include configuring the manufacturing systems and methods in accordance with life cycle analysis and production input component availability (e.g., material shortage, obsolescence forecasting, etc.).

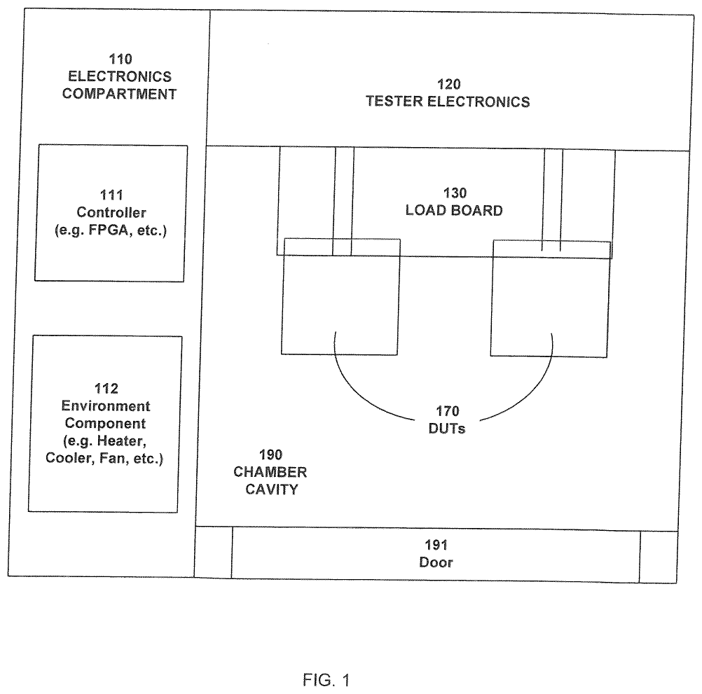

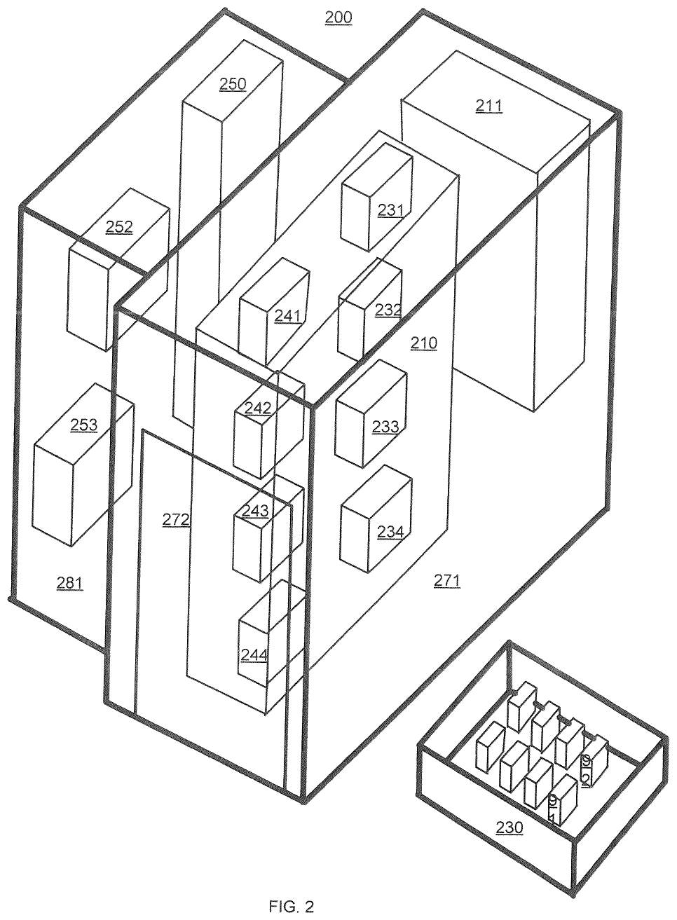

FIG. 1 is a block diagram of an exemplary testing system 100 in accordance with one embodiment. The components of testing system 100 are configured together as a result of engineering and manufacturing processes. Testing system 100 includes electronics compartment 110 and tester electronics 120, load board 130, DUTs 170, and testing chamber 190 with door 191. Electronics compartment 110 includes controller 111 and environment component 112. The supply and configuration of components have a significant impact on the efficiency and effectiveness of testing system 100 fabrication.

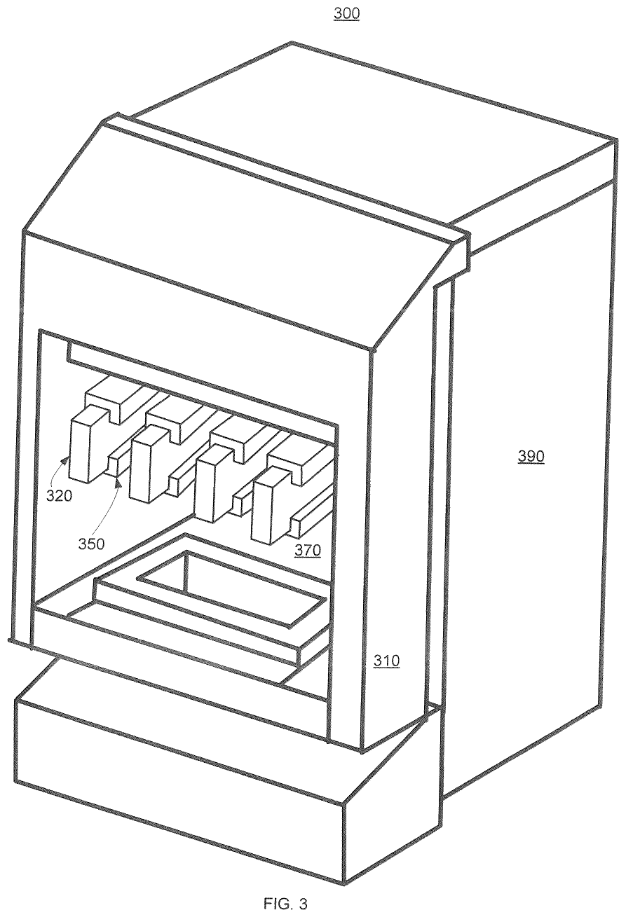

FIG. 2 is a block diagram of another exemplary testing system 200 in accordance with one embodiment. It includes a large controlled environmental chamber or oven 271 that contains an oven rack 210 and heating and cooling elements 211. The oven rack 210 contains devices under test (DUTs) in a number of load board trays 231, 232, 233, 234, 241, 242, 243, and 244. The environmental test chamber 271 has solid walls and a solid door 272 that enclose the test rack 210. The heating and cooling elements 211 can have a wide temperature range (e.g., −10 to 120 degrees C.). The tester or test head 281 contains various racked components, including system controller network switches 252, system power supply components 253, and tester slices 250 (the tester slice contains the tester electronics). The load board trays (e.g., 230, 231, etc.) are connected to tester slices 250 (multiple load board trays can be coupled to a single tester slice). There is also a block diagram of a tester tray 230 and devices under test (e.g., 291, 292, etc.). The load board trays are populated with devices under test. The full tester trays (e.g., 230, 231, etc.) are inserted into environmental chamber 271 and connected to the tester electronics (e.g., 250, 252, 253, etc.). This process can be labor intensive and cumbersome (e.g., the process requires opening the door 272 of the environmental chamber 271 and manually trying to insert the trays though the door 272 into the appropriate location).

Similar to the fabrication of testing system 100, the supply and configuration of components have a significant impact on the efficiency and effectiveness of testing system 200 fabrication. While the overall impact of component supply and configuration can have similar significant impact, it is noted the two systems can have differences. Differences in supply and configuration of components can increase the complexity and difficulty of the manufacturing processes.

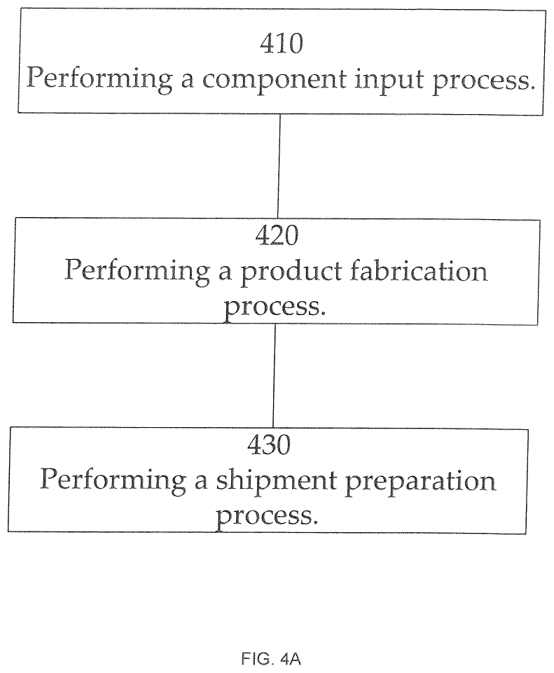

In one embodiment, a test system includes a device interface board and a primitive (e.g., tester electronics and enclosure). The device interface board has a partial enclosure with a device under test access interface that allows convenient and efficient physical manipulation of the devices under test (e.g., manual manipulation, robotic manipulation, etc.). FIG. 3 is a block diagram of an exemplary test system 300 in accordance with one embodiment. Test system 300 includes a testing primitive 390 and a device interface board (DIB) 310 disposed in front of and coupled to the primitive 390. The device interface board 310 partial enclosure includes a device under test access interface 370 that enables easy physical access (e.g., unobstructed, unimpeded, etc.) to the devices under test. Environmental control components control and maintain device under test ambient environmental conditions (e.g., temperature, air flow rate, etc.), including creating an environmental envelope that prevents or mitigate interference from outside environmental conditions on the operations of devices under test. Again, the supply and configuration of components to the manufacture of test system 300 can shave a significant impact on the efficiency and effectiveness of testing system 300 fabrication.

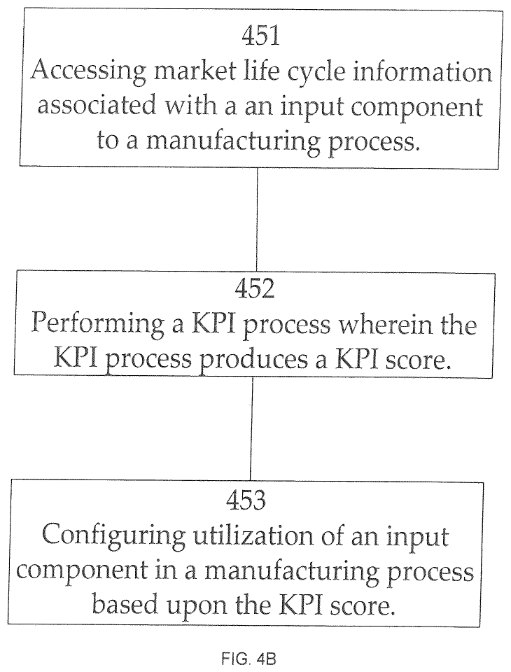

FIG. 4A is a block diagram of an exemplary output product manufacturing process 400 in accordance with one embodiment. In one exemplary implementation, the manufacturing process is an ATE manufacturing process.

In Block 410, a component input process is performed. In one embodiment a component input process includes configuring/determining components to be input to the process. In one embodiment, the component input process includes receiving the input component.

In block 420, an output product fabrication process is performed. In one embodiment, the input components are assembled into an output product. In one exemplary implementation, the output product is a test system.

In block 430, a shipment preparation process is performed. The shipment preparation process can include inspection, calibration, packaging, and so on.

FIG. 4B is a block diagram of an exemplary a life cycle manufacturing input control method 450 in accordance with one embodiment. In one exemplary implementation, the manufacturing process comprises manufacture of test equipment.

In block 451, market life cycle information is accessed. In one embodiment, the market life cycle information is associated with an input component to a manufacturing process. In one embodiment, the market life cycle information comprises active input component/production availability information, inactive input component/production availability information, and input component obsolescence information. In one exemplary implementation, the market life cycle information comprises: an input component/product “Active” section comprising an Active-Widely Available stage, an Active-Limited Available stage, and an Active-MOQ stage, am input component/product “Inactive” section comprising an Inactive-Not Recommend for New Design stage, an Inactive-Last Time to Buy/Last Available stage, and Inactive-Last Time Buy MOQ stage; and an input component/product “Obsolete” section comprising an Obsolete-Widely Available stage, an Obsolete-Limited Available stage, and an Obsolete-Limited Available stage.

In block 452, a KPI process is performed, wherein the KPI process produces a KPI score. In one embodiment, the KPI process comprises: determining life cycle stage of the input component, assigning a confidence factor to the life cycle stage, and establishing a KPI score. In one embodiment, the KPI score is defined by: KPI Score =CF×(P+α)×Q/CT, wherein CF is a confidence factor, P is a probability of obtaining an input component, α is a percentage of in-stock suppliers/distributors, Q is the quality of the bill of materials (BOM), C is the cost and T is the lead time.

In block 453, an input component is configured for utilization in a manufacturing process based upon the KPI score. In one embodiment, stage features of the market life cycle information are analyzed. In one embodiment, configuring utilization of an input component in a manufacturing process comprises establishing a bill of material.

Difficulties in product manufacturing processes are often associated with manufacturing component input operations (e.g., engineering, component configuration, the actual timing of input component arrival, etc.), and difficulties in the initial component input process typically result in detrimental impacts that propagate throughout the rest of the manufacturing process. The component input process has significant efficiency and effectiveness implications for a manufacturing process. Input component shortage has been a critical issue in most conventional product manufacturing processes.

In one exemplary implementation, an occurrence of input component shortage is typically dependent on input component suppliers. The term supplier can be use broadly to refer to various entities in a supply chain (e.g., input component manufacturer, input component distributor, etc.). It is appreciated that an input component can be the result or output of a first manufacturing process and is forwarded/shipped as an input component to a second manufacturing process. Thus, a manufactured input component life cycle can be similar to a manufactured product life cycle. As such, an input component life cycle can significantly influence when an input component shortage may occur and insight into the occurrence of an input component shortage is typically dependent on timely receipt of information from input component suppliers.

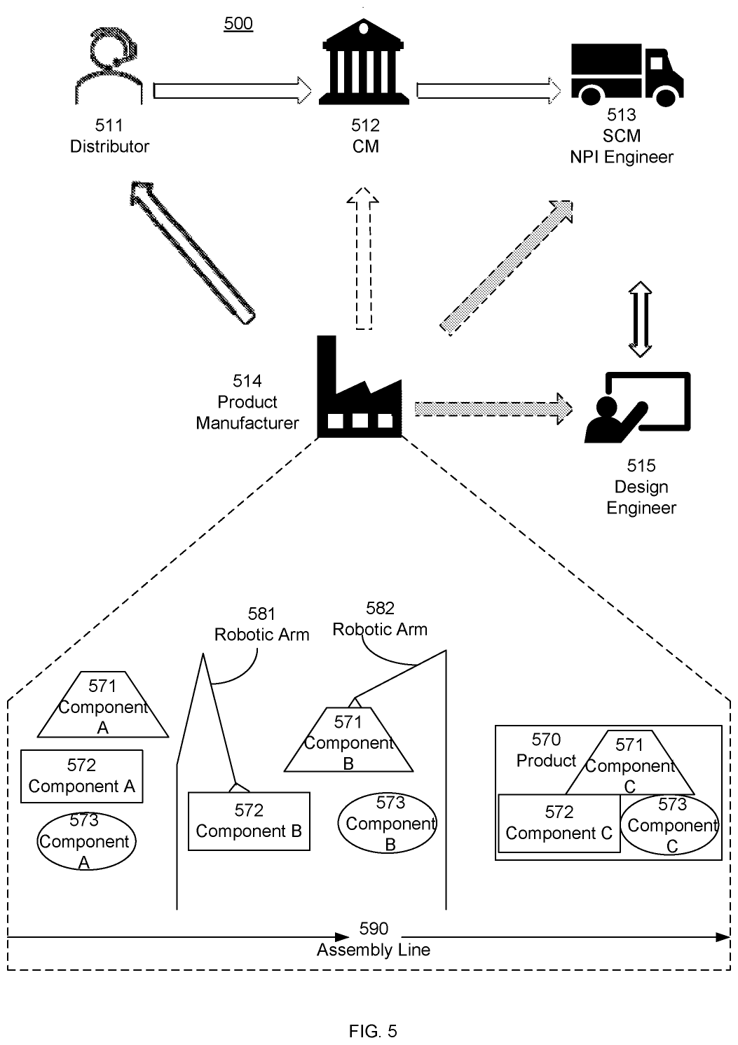

FIG. 5 is a block diagram of an exemplary input component information flow 500 in accordance with one embodiment. In one embodiment, an input component/product information flow is similar other product manufacturing process information flows.

The communication channel and the visibility to manufacturer information can be driven by various factors (e.g., business partnership, order volume and frequency, technical connections, etc.). The communication channel between manufacturer 514 and supplier/distributor 511 is typically very solid, while the communications with a CM 512, supply chain management SCM 513 or top customers may vary and are not typically solid. The information exchange between manufacturer 514 and engineers (e.g., new product introduction (NPI) engineer 513, design engineer 515, etc.) are traditionally comparingly poor most of the time. In low volume high mix product design environments (such as ATE manufacturing, etc.) engineers and operations personnel may conventionally obtain very little real-time material availability information when including parts in ATE designs and BOM. However, with new KPI score information, meaningful information regarding input component availability can be efficiently and effectively communicated to the engineers and operations personal, unlike conventional approaches that gave little or no warning of availability issues. In one exemplary implementation, the KPI score and availability information is communicated with sufficient lead time that input component configuration provisions (e.g., decision to incorporate, order the input component, receive the input component, etc.) are made and executed in a manner the incurs minimal or no disruption to a production process.

In one embodiment, product manufacturer 514 includes an assembly line 590. Manufacturing input components (e.g., 571A, 572A, 573A, etc.) are received from component suppliers. The components (e.g., 571B, 572B, 573B, etc.) are assembled. In one exemplary implementation, the robotic arms 581 and 582 participate in assembling the components. A resulting manufactured output product 570 is output by the assembly line 590. If there is a delay or other difficulty receiving the input components (e.g., 571A, 572A, 573A, etc.) the whole assembly line and output product production can be adversely impacted.

Due to resource restrictions or cost effectiveness, many design companies rely on a CM to update BOM status and provide component lifecycle change information. In many traditional cases design companies receive delayed information or even miss an input component/product change notice (PCN) because a CM does not actively reach out to collect information for every component. Such delays are typically harmful to output product delivery when the information is related to component obsolete or LTB.

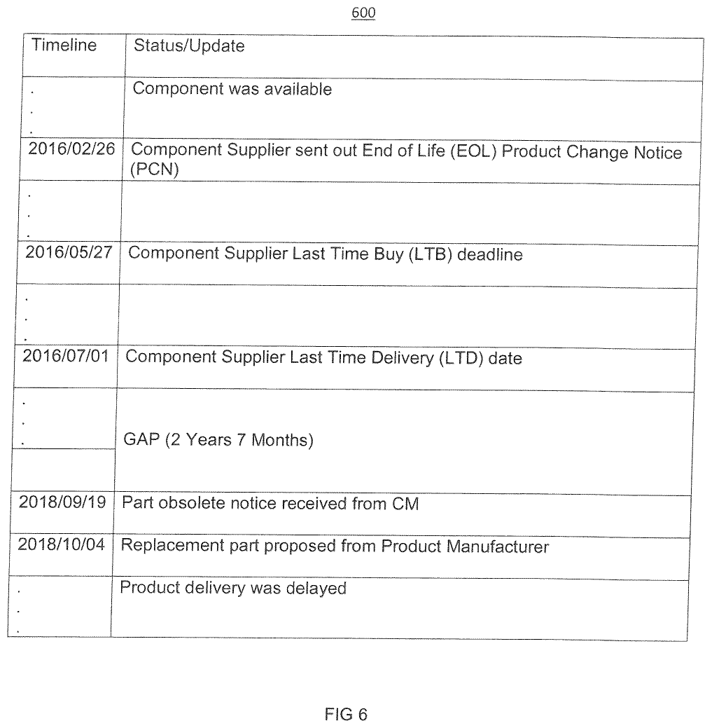

FIG. 6 is a table of an exemplary traditional BOM component timeline 600 in accordance with one embodiment. In the example, the BOM component is available from the component supplier before Feb. 26, 2016. However, due to a communication gap between the CM and the manufacturer the component EOL information was delayed 2 years and 7 months. Even though the manufacture is also the design company of the output product and came up with a quick replacement solution, the information delay still resulted in output product delivery delay.

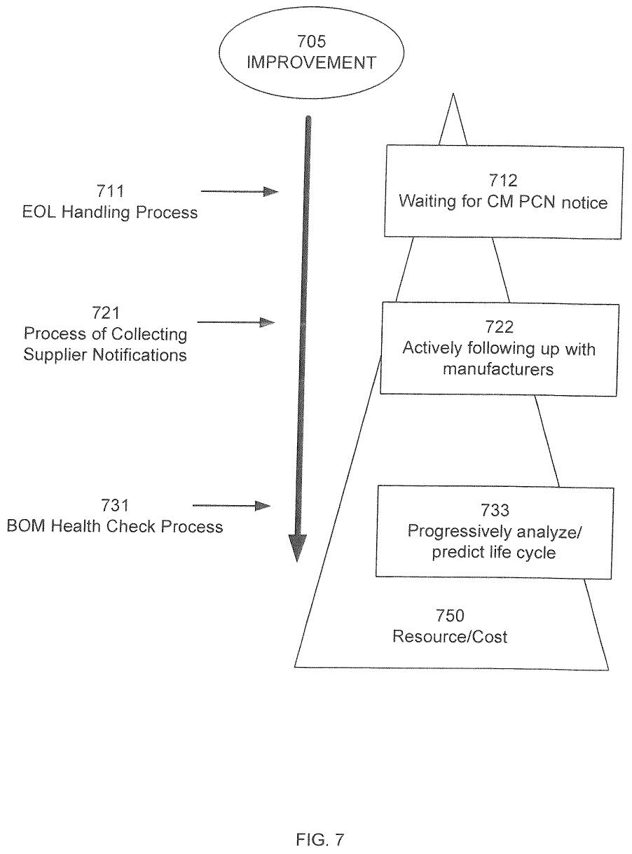

FIG. 7 is a block diagram of an exemplary health check flow 700 in accordance with one embodiment. Health check flow 700 includes EOL handling process 711, collecting supplier notification process 721, and BOM health check process 731. EOL handling process 711 includes waiting for CM PCN notice 712. Collecting supplier notification process 721 includes actively following up with input component manufacturers 722. BOM health check process 731 includes progressively analyzing/predicting life cycle 733. The resources/costs 750 increase as the processes proceed with more active involvement and with improvement 705 being realized by the presented systems and methods.

In one embodiment, input component obsolescence is primarily handled in a three stage approach (e.g., shown in FIG. 7, etc.). Traditionally, many companies may wait for a CM to provide a PCN and in response trigger an end of life (EOL) handling process (e.g., resulting in a delay similar to the delay in FIG. 6, etc.). In one embodiment, a better case (e.g., achieved by the novel market life cycle approaches presented herein, etc.) is to not necessarily wait for the CM to provide a PCN to initiate active follow up, rather reach out and initiate active pursuit of information. In one embodiment, the information includes publicly available information in the market. In one exemplary implementation, manufactures of an output product actively communicate with input component/product manufacturers pursuing timely information/notifications. In one embodiment public information is combined with other types of information (e.g., private information that is selectively shared, information that is deduced from public events, etc.). In one exemplary implementation, a preferred practice is to progressively analyze lifecycle of components with BOM health check.

While the benefits of the improved novel presented approach are evident, the resource cost increments from passive mode to proactive mode in the past have traditionally presented significant obstacles. In one exemplary implementation, the novel presented systems and methods introduce a market life cycle approach that facilitates utilization of available market data and information in a distribution network to forecast input component lifetime and availability. In one embodiment, with this approach, design companies can proceed with a BOM health check with little to no resource or cost increase.

In one embodiment, the presented systems and methods convert simple available and previously unavailable information regarding manufacturing input components in a market into a predictable input component market life cycle, through strategy analysis and performance analysis.

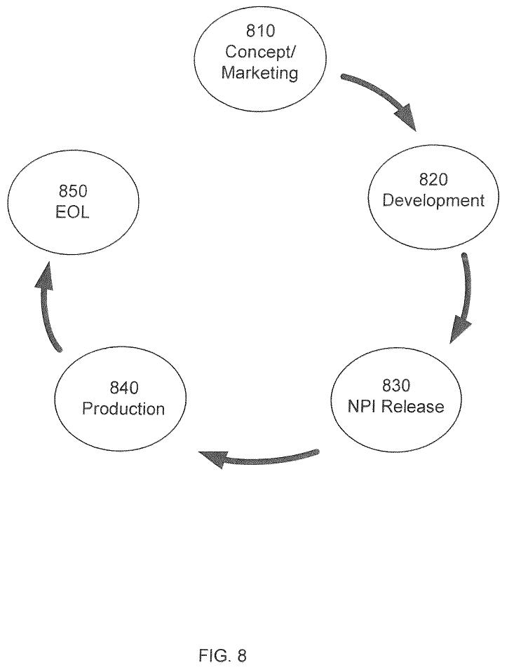

FIG. 8 is a block diagram of an exemplary input component/product life cycle flow 800 in accordance with one embodiment. Product life cycle flow 800 includes concept/marketing block 810, development block 820, NPI increase block 830, production block 840, and EOL block 850.

In one exemplary implementation, FIG. 8 demonstrates a widely used product life cycle model, from concept or marketing evaluation, through product development and release, through volume production, until End-of-Life. From the input component/product owner or input component/manufacturer's perspective, life cycle planning and schedule are very intuitive and manageable. However, when an output product from a first process is essentially an input component to a second manufacturing process (e.g., for a different, second output product, etc.), the incoming component consumers of the first product process are the product manufacturers of the second process. Unfortunately, input component/product consumers in the second process traditionally have little or no access to the input component/product life cycle information from the first process. Thus, the product manufacturers of the second process traditionally have little or no product life cycle information regarding input components in a timely manner. Such information unavailability is especially harmful to low volume product manufacturers like the ATE industry.

In the initial stages of a product life cycle (e.g., before a product release stage, etc.) information is mostly an input component manufacturer's confidential information that an output product manufacturer does not traditionally have access to. After a product is released to market, the information regarding the rest of the life cycle stages is typically publicly available to consumers of the product (e.g., including other product manufactures that use the product as an input component, etc.). Therefore, the presented market life cycle approach makes good use of the publicly available information regarding an input component/product on the market and performs in-depth combined product/market based analysis on the production-to-EOL transfer. Novel input component market life cycle approaches presented herein provide novel information to the manufacturers of the second process (e.g., the output product, etc.) in a timely manner, unlike traditional product life cycle approaches.

Systems and methods are presented that provide insight to input component obsolescence and End-of-Life (EOL) based on an input component market life cycle model. In one embodiment, a forecast regarding future input component conditions is utilized in the configuration of present and future manufacturing input components. It is appreciated the forecast can be utilized in input component configuration decisions at various times (e.g., at the time the forecast is made, at a future time, etc.). In one embodiment, a 3-section-9-stage model is utilized in which real time inventory and lead time information is collected from market distribution networks, then interpreted in accordance with historical trends, and analyzed in such a way that maps input component availabilities in input component market life cycle management. This model interconnects visibility of input component/product consumers and otherwise limited information disclosed by product manufacturers, providing warning signals of input component/product changes and forecasting input component/product shortage information. Life cycle stage features and KPI analysis are also introduced to quantize the market life cycle model for different business focuses. In one embodiment, the terms of obsolescence and EOL may be used interchangeably and the terms component and part may be used interchangeably.

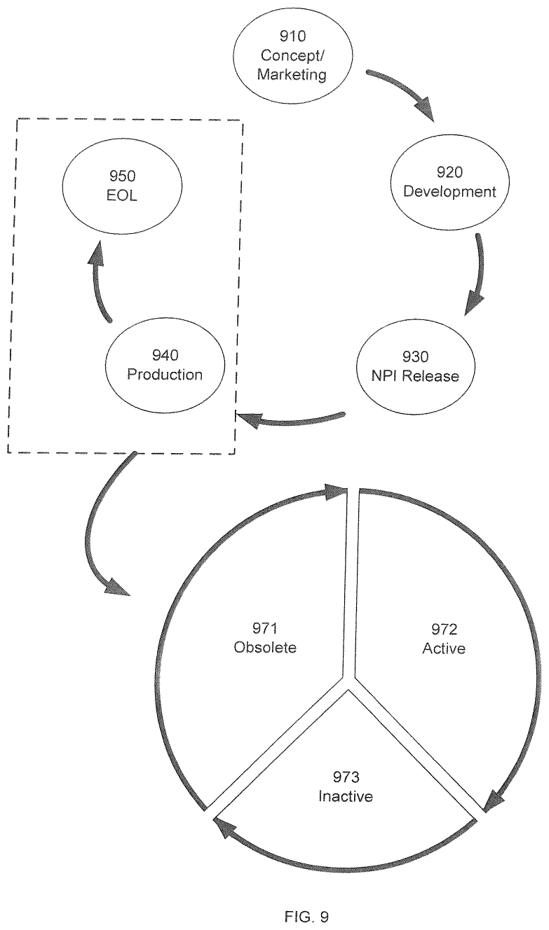

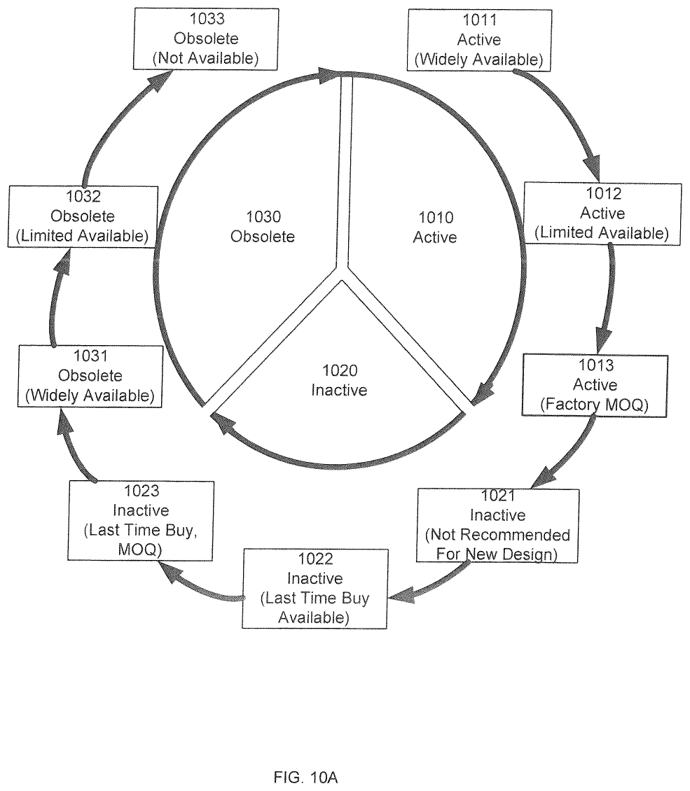

FIG. 9 is a block diagram illustrating difference between an exemplary product life cycle flow and a market life cycle flow in accordance with one embodiment. Product life cycle flow 900 is similar to product life cycle flow 800. Product life cycle flow 900 includes concept/marketing block 910, development block 920, NPI increase block 930, production block 940, and EOL block 950. Production block 940 and EOL block 950 follow a market life cycle flow. The market life cycle flow 970 includes an active section 971, an inactive section 972, and an obsolete section 973.

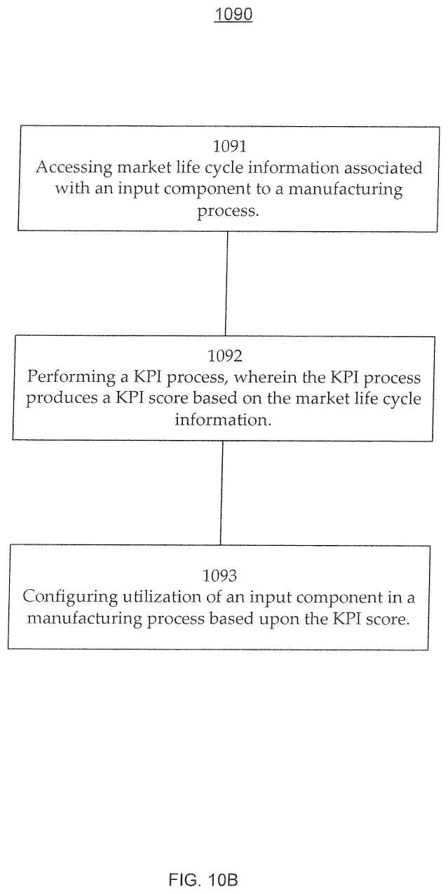

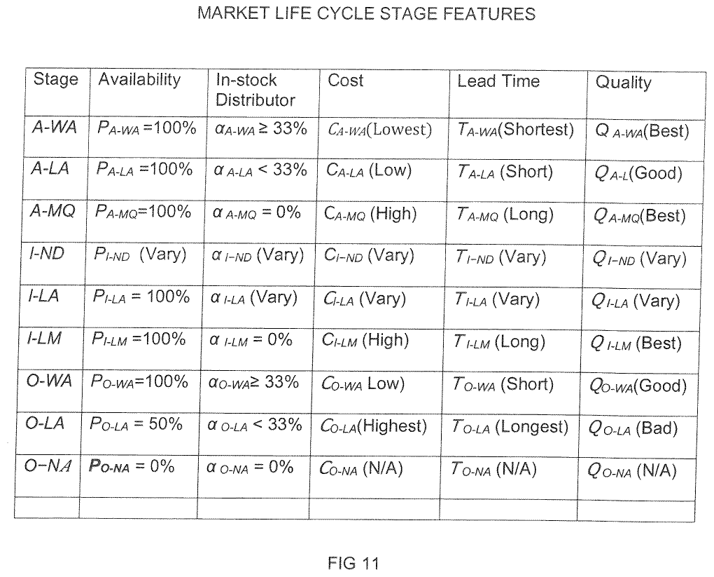

FIG. 10A is a block diagram of an exemplary market life cycle flow 1000 in accordance with one embodiment. In one embodiment, the market life cycle of an input component/product is defined in three sections: “Active” 1010, “Inactive” 1020, and “Obsolete” 1030. Transitions from one section to another are triggered by multiple types of market information. In one exemplary implementation, the market life cycle is an observation & analysis of market supply and demand for a product (e.g., including an input component/product, etc.). Unlike the product life cycle that ends up with product termination, the market life cycle approach may continue with a different input component/product. In one exemplary implementation, the different input component is a direct drop-in (e.g., pin-to-pin, etc.) replacement.

In one embodiment, the 3 sections of market lifecycle are extended into 9 detailed stages. With reference still to FIG. 10, the “Active” section 1010 includes 3 stages: the Widely Available stage 1011, the Limited Available stage 1012, and the Factory MOQ stage 1013. The “Inactive” section 1020 includes Not Recommend for New Designs (NRND) stage 1021, Last Time Buy (LTB) Available stage 1022, and Last Time Buy with MOQ stage 1023. The “Obsolete” section 1030 covers the post EOL stages, which are Obsolete and Widely Available stage 1031, Obsolete and Limited Available stage 1032, Obsolete and Not Available stage 1033. Additional description of the stages is presented in other portions of the detailed description section.

In one embodiment, shortage forecasting heavily depends on the input component/product information disclosed by input component/product manufacturers (e.g., including input component/product status, EOL, LTB notice, replacement recommendation, etc.). In one exemplary implementation, information regarding market life cycle stages and availability tolerance versus lack of availability of an input component is accessed, and based upon the information a key performance index (KPI) score is developed. The KPI score is used in input component selection and configuration. In one embodiment, the information regarding market life cycle stages includes publicly available information.

FIG. 10B is a flow chart of an exemplary life cycle manufacturing input control method 1090 in accordance with one embodiment. In one exemplary implementation, life cycle manufacturing input control method 1090 is a KPI score based component configuration method.

In block 1091, market life cycle information associated with an input component to a manufacturing process is accessed. In one embodiment, the input component market life cycle information comprises active production availability information, inactive production availability information, and obsolescence information. In one exemplary implementation, the market life cycle information comprises: an input component/product “Active” section comprising an Active-Widely Available stage, an Active-Limited Available stage, and an Active-Minimum Order Quantity (MOQ) stage, an input component/product “Inactive” section comprising an Inactive-Not Recommend for New Design stage, an Inactive-Last Time to Buy/Last Available stage, and Inactive-Last Time Buy MOQ stage; and an input component/product “Obsolete” section comprising an Obsolete-Widely Available stage, an Obsolete-Limited Available stage, and an Obsolete-Limited Available stage.

In block 1092, a KPI process is performed, wherein the KPI process produces a KPI score based on the input component market life cycle information. In one embodiment, the KPI process comprises determining life cycle stage of the input component, assigning a confidence factor to the life cycle stage, and establishing a KPI score. In one exemplary implementation, stage features of the input component market life cycle information are analyzed.

In block 1093, an input component utilization is configured based upon the KPI score and the input component is input to a manufacturing process. In one exemplary implementation, the manufacturing process comprises manufacture of test equipment. In one embodiment, configuring utilization of an input component in a manufacturing process comprises establishing a bill of material.

There are several acronyms utilized throughout this description. The following is an explanation and definition of some of the acronyms utilized to describe the manufacturing information.

| | |
|---|---|
| L - xx: | A stage in the input component market life cycle, where L is |
| | section A (Active), I (Inactive), O (Obsolete), xx is the |
| | stage in individual section. |
| P_{L-xx}: | Probability of obtaining input component, aka the chance |
| | to procure input component/part either from market or |
| | directly from manufacturer. |
| α_{L-xx}: | Percentage of in-stock suppliers/distributors. |
| C_{L-xx} | Procurement cost of an input component/product. |
| T_{L-xx}: | Lead time of an input component/product. |
| Q_{L-xx}: | Input component/product quality, such as date code, shelf life, |
| | manufacturing location, etc. |

In one embodiment, the input component/product “Active” section includes Active-Widely Available stage, Active-Limited Available stage, and Active-MOQ stage.

The stage Active-Widely Available (A-WA) means an input component/product is available in stock or inventory at most suppliers/distributors. The percentage of in-stock suppliers/distributors (α_{A-WA}) can be customized based on operation tolerance. In one exemplary implementation, P_{A-WA}=100% and α_{A-WA}≥33%. With full probability of P and high percentage of α, procurement cost (C_{A-WA}) and input component/product quality (Q_{A-WA}) can be optimized. The lead time (T_{A-WA}) including shipment can also be minimized.

The stage Active-Limited Available (A-LA) means an input component is available in stock only at limited number of suppliers/distributors. In one exemplary implementation, P_{A-LA}=100% and α_{A-LA}<33%. The chances of optimizing the procurement cost (C_{A-LA}), the input component/product quality (Q_{A-LA}), and the lead time (T_{A-LA}) are also limited compared to the stage A-WA.

The stage Active-Minimum Quantity (MQ) (aka MOQ) (A-MQ) means an input component is not available immediately from any supplier/distributor, but orderable through a supplier/distributor to an input component manufacturer with a required minimum quantity. The stage A-MQ may be caused by several reasons, such as logistic issue, raw material shortage, manufacturing capacity, natural disaster, and so on. In one embodiment, a common reason is the delivery priority has been changed by the input component/product manufacturer/supplier/distributor, which is driven by market demand, technology innovation, other higher profitable products, and so on. In one embodiment, at the stage A-MQ, the probability of getting an input component/product is mostly P_{A-MQ}=100% with little risk, but in-stock probability is α_{A-MQ}=0%. Since purchase orders are often directly placed to a manufacturer under MQ requirements, the procurement cost C_{A-MQ} is not typically negotiable or even worse if considering unnecessary over-ordered quantity. In one exemplary implementation, the lead time T_{A-MQ} is much longer than the previous stages because it includes partial or full manufacturing lead time. In one embodiment, the quality Q_{A-MQ} is the best as fresh build input components/products directly from manufacturer.

The stage A-MQ gives input component/product consumers a warning signal that the input component/product delivery encounters certain changes for some reasons. Such changes may or may not disappear for a period of time, therefore life cycle stage may or may not be recovered.

In one embodiment, the “Inactive” section covers an input component/product transition period from active to obsolete, with communications from input component/product manufacturer to input component/product consumers through PCNs. The duration of the “Inactive” section is generally defined by the manufacturer's PCNs. In one embodiment, the input component/product “Inactive” section includes Inactive-Not Recommend for New Design stage, Inactive-LTB and Available stage, and Inactive-Last Time Buy MOQ stage.

In one embodiment, the stage Inactive-Not Recommend for New Design (I-ND) is the first communication stage where a manufacturer voluntarily sends notification to suppliers/distributors that an input component/product will soon enter the obsolete stage (e.g., the input component manufacturer does not recommend the product to output product manufacturers/consumers in their new unreleased designs, etc.). Unlike the stage A-MQ, the stage I-ND is typically a manufacturer/supplier confirmed stage where the input component/product starts its way to EOL. Since this stage I-ND is mostly a communication with input component/product status update, it is not directly related to input component market availability. So P_{I-ND}, α_{I-ND}, C_{I-ND}, T_{I-ND}, and Q_{I-ND} may vary for input component/product to input component/product in a market.

The staged Inactive-Last Time Buy (LTB) and Last Available (I-LA) are the stages when an input component/product manufacturer officially sends out PCNs to suppliers/distributors and input component/product consumers about their EOL plan, including the impacted input component/product number, EOL date, LTB order date, LTB ship date, recommended drop-in replacement if any, and so on. Meanwhile the input component/product is available in the market for purchasing. In one exemplary implementation of the stage I-LM, the availability P_{I-LA}=100% but α_{I-LA} varies. Because the LTB PCN generally triggers input component/product consumers to take some preventative actions such as safety stock purchase or BOM update with alternative input component/product, the procurement cost C_{I-LA}, the input component/product quality Q_{I-LA}, and the lead time T_{I-LA} also change fast depending on input component/product availability on market.

The stage of Inactive-LTB and MOQ (I-LM) is the stage that an input component/product is not available in the market while the LTB window is still open. Input component customers may place an order directly to an input component manufacturer/supplier with or without the MOQ requirement. In one exemplary implementation of the stage I-LM, the availability probability of PI-LM is equal to 100%, and in-stock probability of αI-LM is equal to 0%. In one embodiment, the procurement cost CI-LM and the lead time TI-LM cannot be optimized, but the quality QI-LM is still the best as fresh build input component/products.

The “Obsolete” section covers the period from the end of LTB date to the time when the EOL input component/product is completely not available, either in the market or from a manufacturer. In the “Obsolete” section, the volume of supply is fixed to market inventories. The length of this period depends on the volume of demand. In one embodiment, the input component/product “Obsolete” section includes Obsolete-Widely Available stage, Obsolete-Limited Available stage, and Obsolete-Not Available stage.

The stage Obsolete-Widely Available (O-WA) refers to the period an EOL input component/product is available in stock with most suppliers/distributors. In one exemplary implementation of the stage I-LM, PO-WA=100% and use αO-WA≥33%. However, the LTB date from the manufacturer has passed. Such a situation is mostly caused by either slow demand for an input component/product or a sudden change in active input component/product by a manufacturer/supplier. The input component/product wide availability on market makes this stage similar to the stage A-WA on procurement cost CO-WA, lead time TO-WA, and input component/product quality QO-WA, which can be optimized. But the status is unpredictable and may change anytime because of the stop of input component/product supply.

The stage Obsolete-Limited Available (O-LA) means an EOL input component/product is available at a limited number of suppliers/distributors like α_{O-LA}<33%. Since the availability and inventory information may be unreliable, the probability P_{O-LA}=50%. The procurement cost C_{O-LA}, input component/product quality Q_{O-LA} and lead time T_{O-LA} are also getting worse with time running out.

The stage of Obsolete-Not Available (O-NA) is the last stage in an input component/product life cycle, where the product completely disappears from a market. In one exemplary implementation of this stage P_{O-NA}=0% and α_{O-NA}=0%, no data is related to C_{O-NA}, T_{O-NA}, or Q_{O-NA}. In one embodiment, input component customers take a risk to use brokers who explore second-hand stocks or even used parts.

FIG. 11 is a table of exemplary Market Life Cycle Stage Features in accordance with one embodiment. The table demonstrates the 9-stage 3-section market life cycle of an input component/product, with features of individual stages. To input component/product consumers, the availability (P, α) is the first concern and the pre-condition to optimize other business targets. In business operations, the cost reductions (C↓) are key improvements in productions. The lead time (T↓) from purchase to delivery decides storage space in stockroom while waiting for kitting, it is also a critical feature in Just-In-Time (JIT) operations. The quality (Q↑) of BOM materials are the foundation of high manufacturing yields and good quality input component/product delivery. Giving the minimum inventory cost, the operation goal is max_{(P,α)}Q/CT.

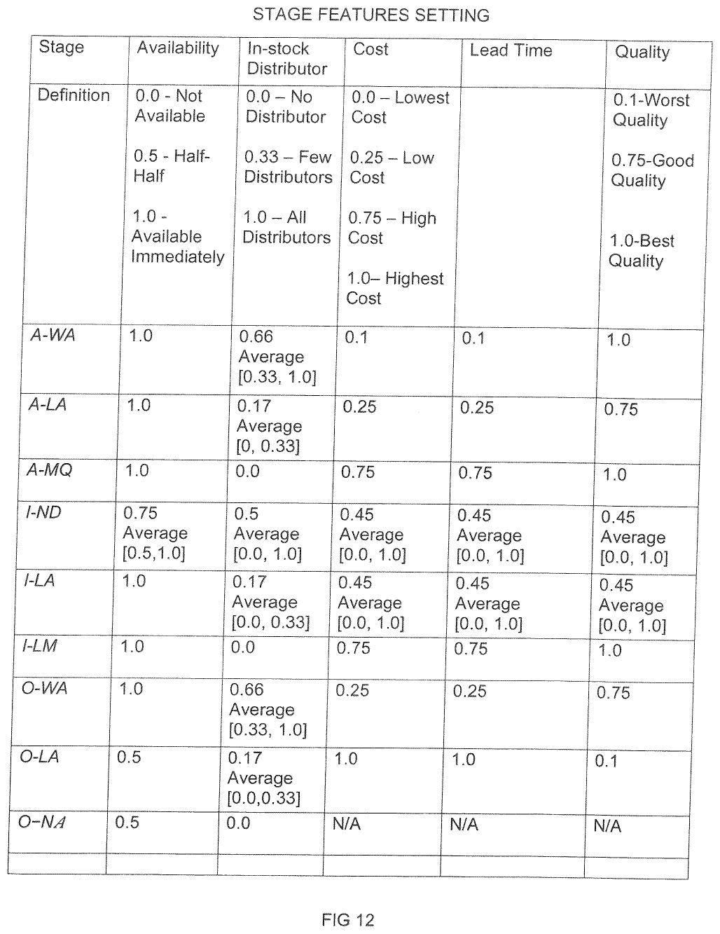

FIG. 12 is a table of exemplary Stage Features Settings in accordance with one embodiment. Based on common operations in one exemplary implementation, the generic settings of stage features are present in the table. In specific situations, the features may be set in a preferred manner for higher priority or certain focus. The ranges of individual features are defined in the “Stage” row, where the boundary values and some middle values are defined in the “Definition” row. In one exemplary implementation, for those “Vary” conditions in the feature table, the average values of the applicable ranges are used.

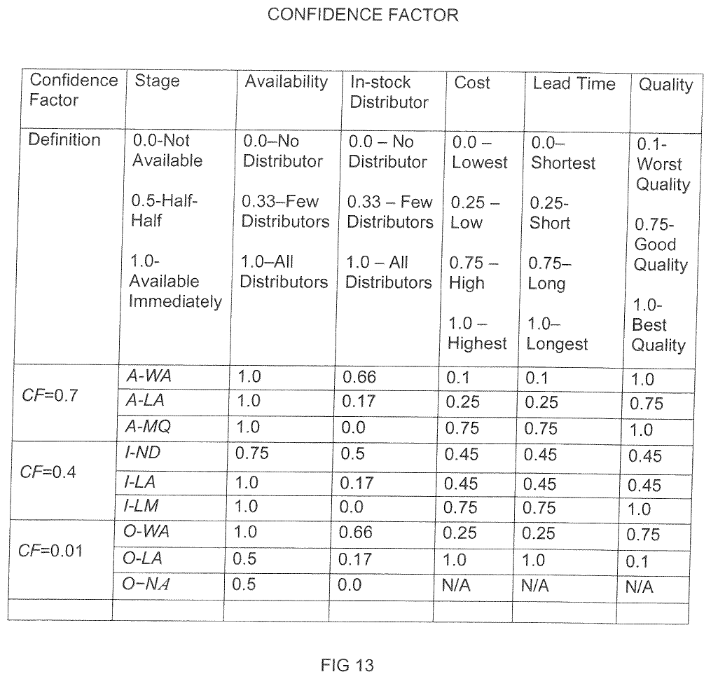

FIG. 13 is a table of exemplary confidence factor indications in accordance with one embodiment. As set forth in the setting table of FIG. 12, some features at certain stages of different sections have similar values. For example, the features of O-WA are mostly the same as A-LA and A-MQ is the same as I-LM. The reason is the difference of three market life cycle sections are not considered. A confidence factor is introduced in FIG. 13 which reflects the operation confidence in individual sections. In this table, the [0.0, 1.0] range is used as a general example, assigning 0.7 to the “Active” section, 0.4 to “Inactive” section, 0.01 to “Obsolete” section.

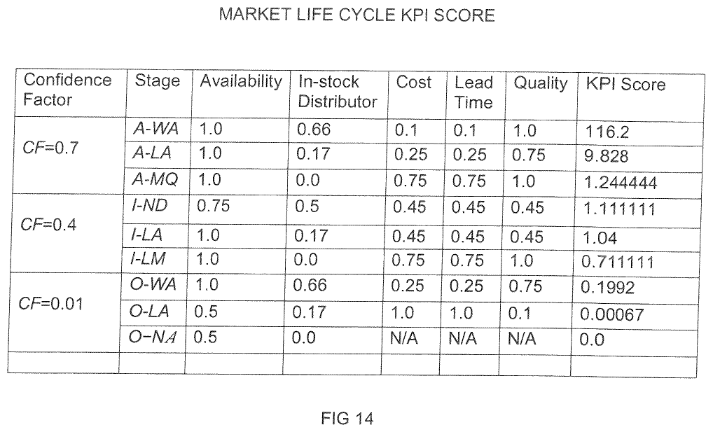

FIG. 14 is a table of exemplary market life cycle KPI score indications in accordance with one embodiment. With confidence factor and stage feature settings, the market life cycle KPI score is calculated. This score shows the overall performance of each stage, and is defined as:

$$KPI Score = CF \times ( P + α ) \times ( Q / CT ) .$$

On the last column the KPI scores of 9 stages are listed under generic value settings.

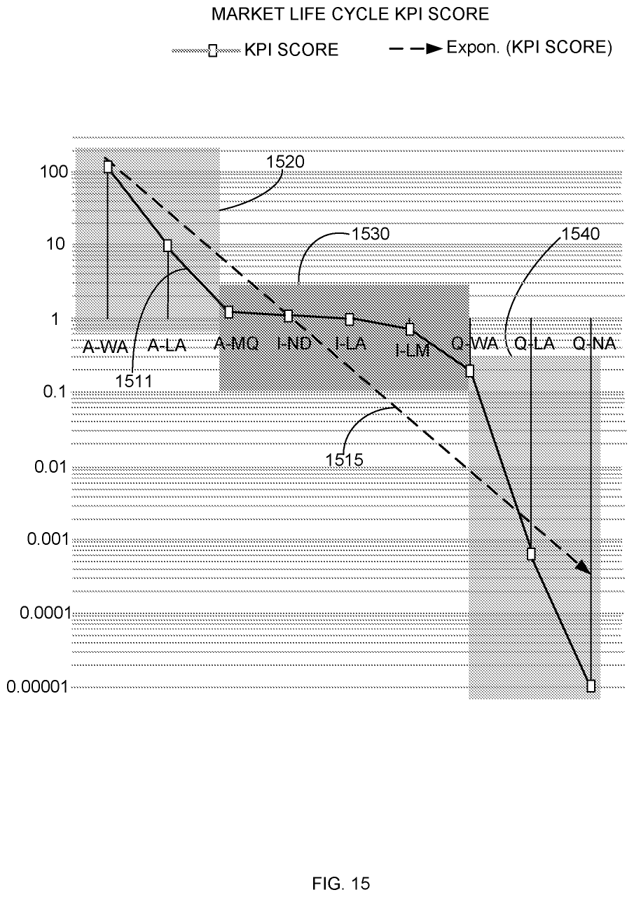

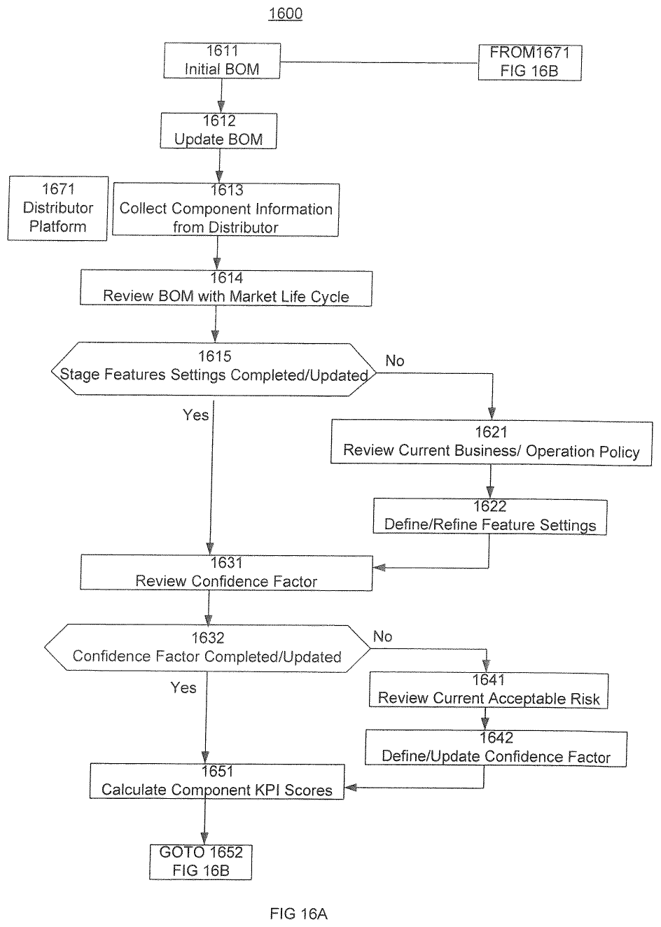

FIG. 15 is another block diagram of exemplary market life cycle KPI score indications in accordance with one embodiment. In the graph, the 1511 solid line plots the KPI score, and the 1515 dotted line is the exponential curve of KPI score. This KPI score plot demonstrates clearly about the performance changes between stages during the 3 sections of market life cycle. The exponential line shows the constant dropping trend along 9 stages. Based on the different slopes in the KPI score plot, the 9 stages are clustered into 3 performance groups. The first group includes A-WA and A-LA, which is performance safe group with KPI score far beyond 1. The second group includes A-MQ, entire inactive section, and O-WA. It is a group under certain risk, the KPI score is around 1. The third group includes O-LA and O-NA, where the KPI score is far below 1.

Along the 9-stage KPI plot, the groups are also associated with safety zones, including safe zone 1520, risky zone 1530, and unsafe zone 1540. The 1520 safe zone requires no extra action for regular demand. The 1530 risky zone needs immediate actions on LTB for safety stock or design update. This zone provides multiple warning signals and sufficient turn time for actions. The 1540 unsafe zone marks the late time for actions and little chance for good performance or quality.

In one embodiment, proactive part obsolescence planning, such as actively following up with suppliers/manufacturers or progressively analyze and predict material life cycle, holds the promise for 20:1 or 100:1 paybacks. In one embodiment, the paybacks include minimal or no interruption/delay to input component/product manufacturing process. In one exemplary implementation, paybacks include an advantageous balance of input component quality, cost, and availability.

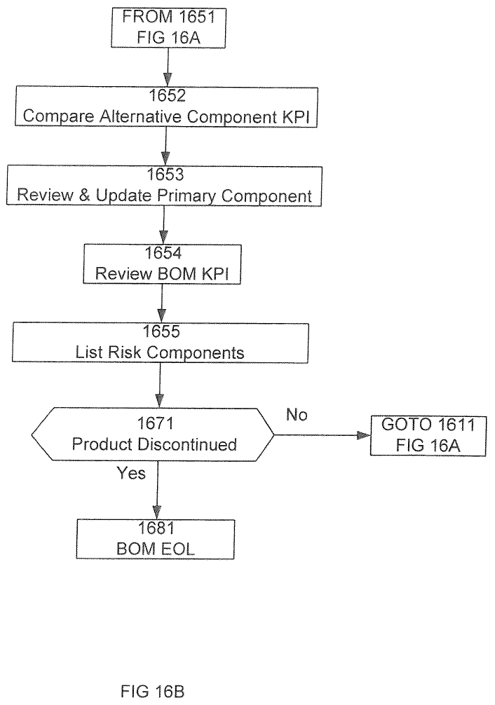

FIG. 16 is a flow chart of an exemplary method in accordance with one embodiment.

In block 1611, an Initial BOM is created. In block 1612, the BOM is updated. In block 1613, input component information is collected from a supplier/distributor. In one embodiment, the information comes from supplier/distributor platform 1670. In block 1614, the BOM market life cycle is reviewed. In block 1615, a determination is made whether stage feature settings are completed and updated. If the stage feature settings are completed and updated the process proceeds with block 1631. If the stage feature settings are not completed and updated the process proceeds with block 1621. In block 1621, a current business/operation policy is reviewed. In block 1622 feature settings are defined/refined.

In block 1631, a confidence factor is reviewed. In block 1632, a determination is made whether the confidence factor is completed/updated. If the confidence factor is completed/updated the process proceeds to block 1651. If the confidence factor is not completed/updated the process proceeds to block 1641. In block 1641, the current acceptable risk is reviewed. In block 1642, the confidence factor is defined/updated.

In block 1651, component KPI scores are calculated. In block 1652, alternative component KPI scores are compared. In block 1653, the primary components are reviewed and updated. In block 1654, the BOM KPI is reviewed. In block 1655, a list of risk components is created. In block 1671, a determination is made whether an input component/product is discontinued. If an input component/product is not discontinued the process returns to block 1612. If an input component/product is discontinued the process proceeds to block 1681 BOM EOL.

In one embodiment, the market lifecycle information is utilized to configure input components for a product manufacturing process. Proper input component configuration often leads to the realization of technological improvements in the output products (e.g., quality of input components contributing to quality of output product, incorporating technology advancements of input components to the output product, etc.) and also improvements in the manufacturing processes themselves (e.g., fewer stoppages/interruptions, faster incorporations of upgrades, etc.). With the novel automated KPI approach to configuring an input component, a level of efficient and effective output products and manufacturing processes is achieved with minimal or no delays/stoppages, a result not practical/possible in traditional approaches (e.g., see stoppage outlined in FIG. 6, etc.).

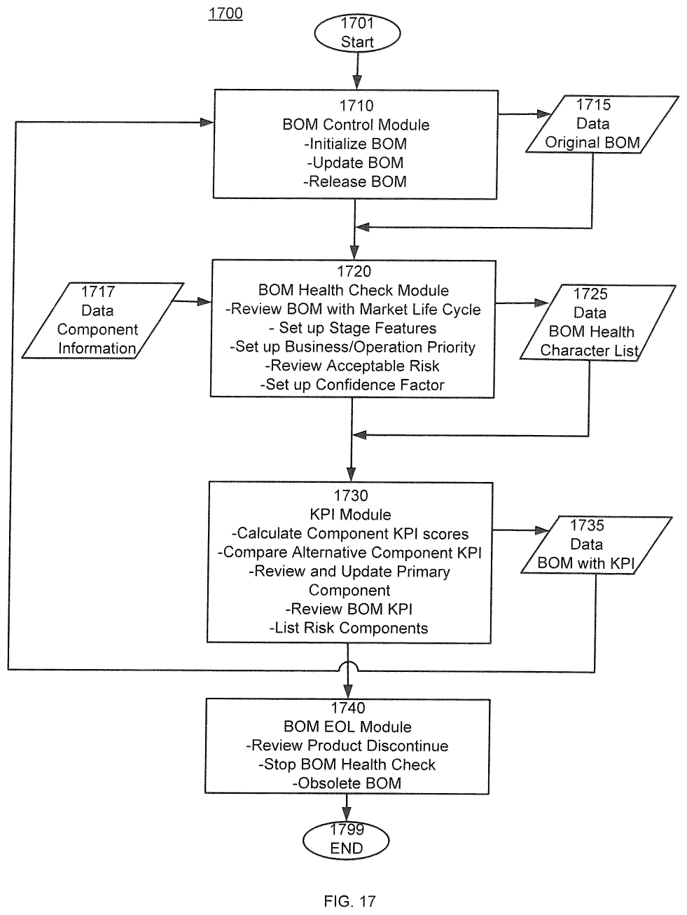

FIG. 17 is a flow chart of an exemplary process flow 1700 in accordance with one embodiment. Process flow 1700 includes start 1701, BOM control module 1710, BOM health check module 1720, BOM Health Check Module 1730, BOM EOL Module 1740 and end 1799. BOM Control Module 1710 includes initializing a BOM, updating the BOM and releasing the BOM. The BOM Control Module 1710 output data 1715 including an original BOM. Data 1715 flows to BOM Health Check Module 1720. BOM Health Check Module 1720 includes reviewing a BOM with a Market Life Cycle, setting up Stage Features, setting up Business/Operation Priority, reviewing Acceptable Risk, and setting up a Confidence Factor. BOM Health Check Module 1720 outputs data 1725 including BOM health information and a character list. Data 1725 flows to KPI module 1730. KPI module 1730 includes deterring component KPI scores, comparing alternative component KPIs, reviewing and updating primary component, review BOM KPI, and list risk components. KPI module 1730 outputs data 1735 including a BOM with KPI scores. Data 1735 flows back to BOM control Module 1710. BOM EOL module 1740 includes review input component/product discontinuation status, stop BOM health check, and identify BOM as obsolete.

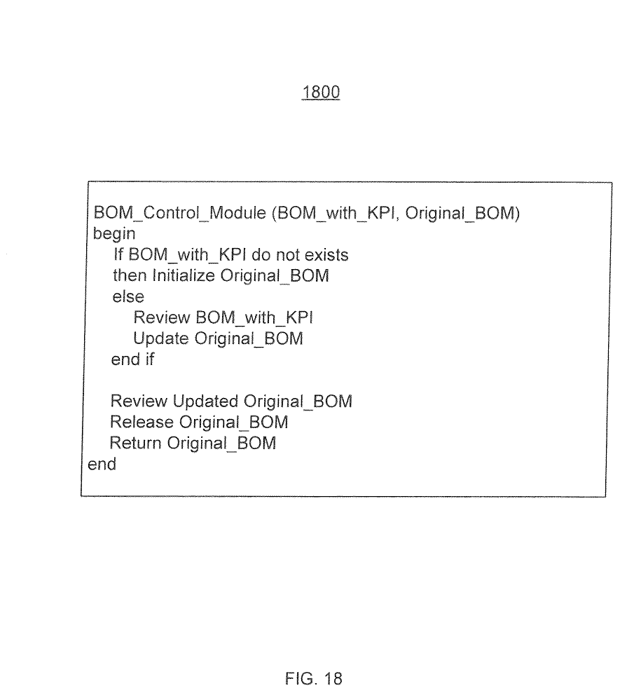

FIG. 18 is an illustration of exemplary BOM Control Module instructions in accordance with one embodiment. In one exemplary implementation, the BOM Control Module instructions are similar to instructions included in BOM Control Module 1710.

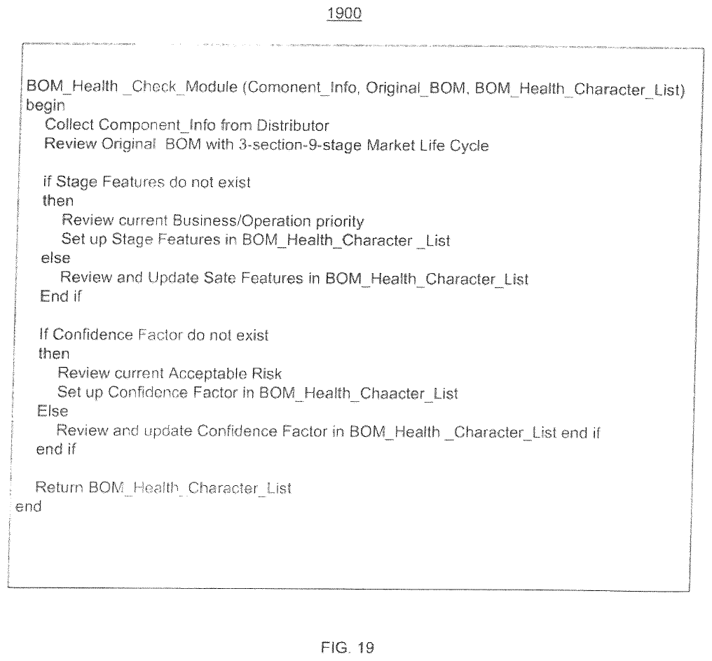

FIG. 19 is an illustration of a table of exemplary BOM Health Check Module instructions in accordance with one embodiment. In one exemplary implementation, the BOM Health Check Module instructions are similar to instructions included in BOM Health Check Module 1720.

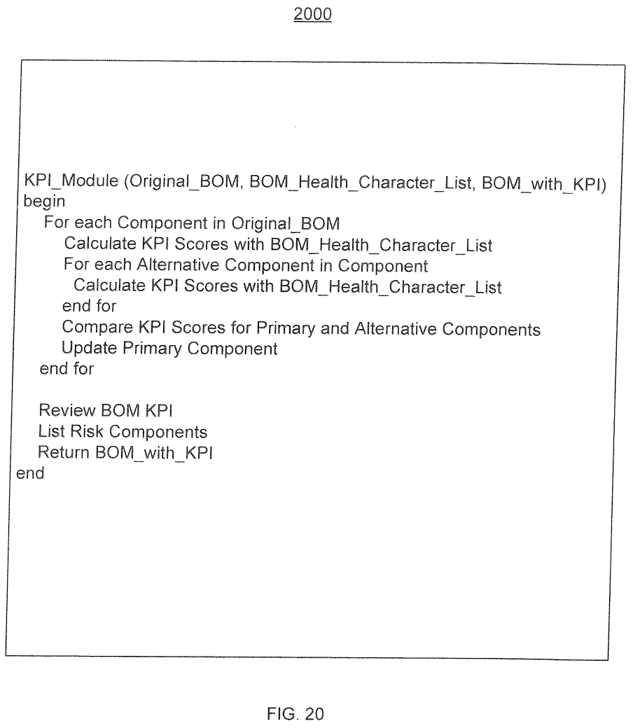

FIG. 20 is an illustration table of exemplary KPI module instructions in accordance with one embodiment. In one exemplary implementation, the KPI module instructions are similar to instructions included in KPI module 1730.

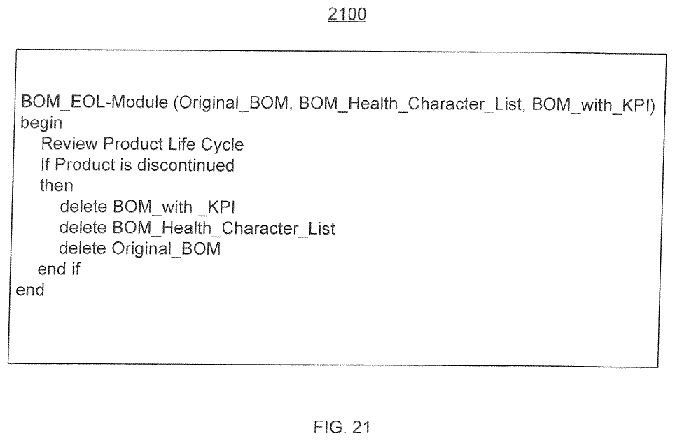

FIG. 21 is an illustration of exemplary BOM EOL module instructions in accordance with one embodiment. In one exemplary implementation, the BOM EOL module instructions are similar to instructions included in KPI module 1740.

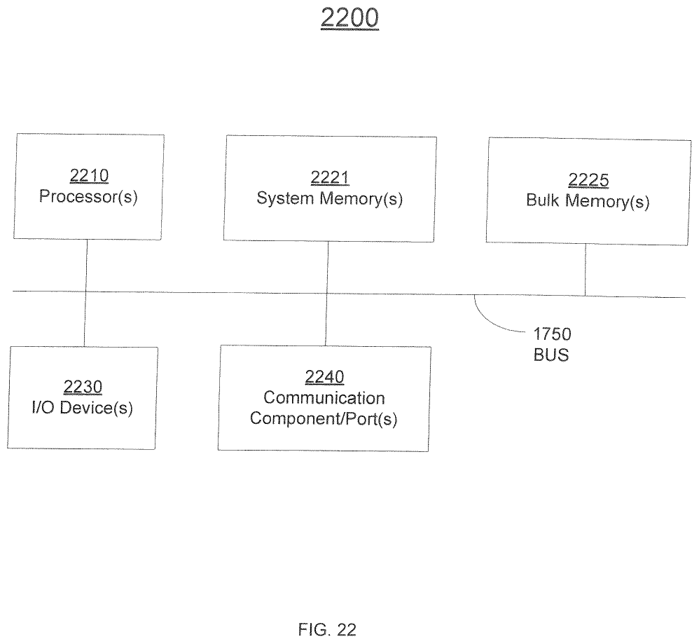

FIG. 22 is a block diagram of an exemplary electronic system 2200 which may be used as a platform to implement and control a process in accordance with one embodiment. Electronic system 2200 can be a “server” computer system. Electronic system 2200 includes a central processor 2210, system memory 2215, bulk memory 2225, input/output (I/O) device 2230, communication component/port 2240, and bus 2250. Bus 2250 is configured to communicatively couple and communicate information between the other components (e.g., central processor 2210, system memory 2215, bulk memory 2225, input/output (I/O) devices 2230, communication component/port 2240, etc.). Central processor 2210 is configured to process information and instructions. System memory 2221 (e.g., reads only memory (ROM), random access memory (RAM), etc.) and bulk memory 2225 is configured to store information and instructions for the central processor complex 2215. I/O device 2230 can communicate information to the system (e.g., central processor 2210, memory 2225, etc.). I/O device 2230 may be any suitable device for communicating information and/or commands to the electronic system (e.g., a keyboard, buttons, a joystick, a track ball, an audio transducer, a microphone, a touch sensitive digitizer panel, eyeball scanner, display component, light emitting diode (LED) display, plasma display device etc.). Communication port 2240 is configured to exchange/communicate information with external devices/network (not shown). A communication port 2240 can have various configurations (e.g., limitation RS-232 ports, universal asynchronous receiver transmitters (UARTs), USB ports, infrared light transceivers, ethernet ports, IEEE 1394, synchronous ports, etc.) and can communicate with an external network.

Traditionally, during supply chain challenges, material shortages and long lead time critical in output product manufacturing and delivery. In addition to ordinary problems, the problematic issues can be significantly exacerbated by extraordinary events, such as international conflicts, natural disasters, pandemics, and so on. The presented systems and methods include design and development of contributions to proactive material obsolete prevention, including market life cycle model, a market life cycle stage feature, and market life cycle KPI score and analysis. In one embodiment, a 3-section 9-stage market life cycle model is configured in such a scheme that efficiently utilizes available input component market information and adapts data into the input component product life cycle forecasting process. In one embodiment, this model covers the potential communication gap between component manufacturer (as supplier) and product design team (as consumer). In one embodiment, the purpose of the stage features is to highlight the most important performances in business operations, including cost, lead time and quality. These features are aligned with availability, in-stock supplier/distributor and confidence factor to accurately reflect differences of the 9 individual stages. The KPI score quantizes the key performance of market life cycle stages, with the designed formula.

While the invention has been described in conjunction with the preferred embodiments, it will be understood that they are not intended to limit the invention to these embodiments. On the contrary, the invention is intended to cover alternatives, modifications, and equivalents. The description is not intended to be exhaustive or to limit the invention to the precise forms disclosed, and obviously many modifications and variations are possible.

Some portions of the detailed descriptions are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

It is appreciated that embodiments of the present invention can be compatible and implemented with a variety of different types of tangible memory or storage (e.g., RAM, DRAM, flash, hard drive, CD, DVD, etc.). The memory or storage, while able to be changed or rewritten, can be considered a non-transitory storage medium. By indicating a non-transitory storage medium it is not intend to limit characteristics of the medium, and can include a variety of storage mediums (e.g., programmable, erasable, nonprogrammable, read/write, read only, etc.) and “non-transitory” computer-readable media comprises all computer-readable media, with the sole exception being a transitory, propagating signal.

It is appreciated that the description includes exemplary concepts or embodiments associated with the novel approach. It is also appreciated that the listing is not exhaustive and does not necessarily include all possible implementation. The concepts and embodiments can be implemented in hardware, firmware, software, and so on. In one embodiment, the methods or process describe operations performed by various processing components or units. In one exemplary implementation, instructions, or directions associated with the methods, processes, operations etc. can be stored in a memory and cause a processor to implement the operations, functions, actions, etc.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the Claims.

1. A life cycle manufacturing input control method comprising:
accessing input component market life cycle information associated with an input component to a manufacturing process;
performing a Key Performance Index (KPI) process, wherein the KPI process produces a KPI score based on the input component market life cycle information; and
configuring utilization of an input component in a manufacturing process based upon the KPI score.

2. The life cycle manufacturing input control method of claim 1, wherein the manufacturing process comprises manufacture of test equipment.

3. The life cycle manufacturing input control method of claim 1, wherein the KPI process comprises:
determining life cycle stage of the input component;
assigning a confidence factor to the life cycle stage; and
establishing a KPI score.

4. The life cycle manufacturing input control method of claim 1, wherein the input component market life cycle information comprises active production availability information.

5. The life cycle manufacturing input control method of claim 1, wherein the input component market life cycle information comprises inactive production availability information.

6. The life cycle manufacturing input control method of claim 1, wherein the input component market life cycle information comprises obsolescence information.

7. The life cycle manufacturing input control method of claim 1, wherein stage features of the input component market life cycle information are analyzed.

8. The life cycle manufacturing input control method of claim 1, wherein the input component market life cycle information comprises:
an input component/product “Active” section comprising an Active-Widely Available stage, an Active-Limited Available stage, and an Active-Minimum Order Quantity (MOQ) stage;
an input component/product “Inactive” section comprising an Inactive-Not Recommend for New Design stage, an Inactive-Last Time to Buy/Last Available stage, and Inactive-Last Time Buy MOQ stage; and
an input component/product “Obsolete” section comprising an Obsolete-Widely Available stage, an Obsolete-Limited Available stage, and an Obsolete-Limited Available stage.

9. The life cycle manufacturing input control method of claim 1, wherein the KPI score is defined by:
KPI Score=CF×(P+α)×Q/CT
wherein CF is a confidence factor, P is a probability of obtaining an input part/component, α is a percentage of in-stock suppliers/distributors, Q is the quality of the bill of materials (BOM), C is the cost and T is the lead time.

10. The life cycle manufacturing input control method of claim 1, wherein the configuring utilization of an input component in the manufacturing process comprises establishing a bill of material.

11. A system comprising:
a memory configured to store instructions;
a processor coupled to the memory, wherein when the instructions are executed by the processor a life cycle manufacturing input control process is performed comprising:
accessing input component market life cycle information associated with an input component to a manufacturing process;
performing a Key Performance Index (KPI) process, wherein the KPI process produces a KPI score; and
configuring utilization of an input component to a manufacturing process based upon the KPI score.

12. The system of claim 11, wherein the manufacturing process comprises manufacture of test equipment.

13. The system of claim 11, wherein the KPI process comprises:
determining life cycle stage of the input component;
assigning a confidence factor to the life cycle stage; and
establishing a KPI

14. The system of claim 11, wherein the input component market life cycle information comprises active production availability information.

15. The system of claim 11, wherein the input component market life cycle information comprises inactive production availability information.

16. The system of claim 11, wherein the input component market life cycle information comprises obsolescence information.

17. The system of claim 11, wherein stage features of the input component market life cycle information is analyzed.

18. The system of claim 11, wherein the configuring utilization of an input component to a manufacturing process comprises establishing a bill of material.

19. The system of claim 11, wherein the KPI score is defined by:
$$KPI Score = CF \times ( P + α ) \times Q / CT$$
wherein CF is a confidence factor, P is a probability of obtaining a part/component, α is a percentage of in-stock supplier/distributors, Q is the quality of the bill of materials (BOM), C is the cost, and T is the lead time.

20. The system of claim 11, wherein the input component market life cycle information comprises:
an input component/product “Active” section comprising an Active-Widely Available stage, an Active-Limited Available stage, and an Active-MOQ stage;
an input component/product “Inactive” section comprising an Inactive-Not Recommend for New Design stage, an Inactive-Last Time to Buy/Last Available stage, and Inactive-Last Time Buy MOQ stage; and
an input component/product “Obsolete” section comprising an Obsolete-Widely Available stage, an Obsolete-Limited Available stage, and an Obsolete-Limited Available stage.
